(19) United States
(12) Patent Application Publication
(10) Pub. No.: US 2009/0229434 A1
(43) Pub. Date: Sep. 17, 2009

(54) DEVICE AND METHOD FOR TRIMMING FOLDED PRINTED PRODUCTS

(75) Inventor: Hans Ulrich Stauber, Grut (CH)

Correspondence Address: RANKIN, HILL & CLARK LLP, 38210 Glenn Avenue, WILLOUGHBY, OH, 44094-7808, US

(73) Assignee: FERAG AG, Hinwil (CH)

(21) Appl. No.: 12/403,840

(22) Filed: Mar. 13, 2009

(30) Foreign Application Priority Data
Mar. 17, 2008 (CH) 00390/08

(51) Int. Cl. B26D 7/06; B26D 7/00

(52) U.S. Cl. 83/23; 83/151

(57) ABSTRACT

A method and a device for trimming printed products (100) on the front edges (104) (frontal trimming) and/or on the lateral edges (106, 108) (head-foot-trimming). The products (100) are inserted into moved receiving compartments along a closed circuit (U), the compartments being open on at least one side, preferably on three sides and include blades (32, 42) moved along in this region, which act together with stationary counter blades (34, 44). The depth of insertion of the products (100) is restricted by a support (50) such that the front edges (104) of the products (100) are in the direct vicinity of the open side of the compartments (10), advantageously protruding with their front edges (104) over the moved along blades (32) for the frontal trimming. The edges (106, 108) of the products (100) extending perpendicular to the folded edge (102) are fixed prior to carrying out a trimming by means of a clamping and moving arrangement (20) and only released for the passing on of the printed product.

### BACKGROUND OF THE INVENTION

1. Field of the Invention

The invention is in the field of processing of printed products and pertains to a device and a method for trimming of particularly multi-sheet folded printed products, such as newspapers, magazines and brochures.

2. Description of Related Art

Folded printed products are usually trimmed on the edge opposite the folded edge, as well as on both edges perpendicular to the aforementioned edges. This is termed front trimming or head-foot-trimming respectively.

The device described in EP-A 0753 386 has a plurality of pocket-shaped receiving compartments, which rotate around a common rotation axis and thereby are conveyed along a circular circuit. The receiving compartments are formed by two respective radially orientated supporting surfaces. The products are inserted into the receiving compartments with their folded edges ahead and come to rest against a support, which is in the region of the base of the compartment. The support is shaped and arranged such that the products are completely and deeply positioned in the compartment, i.e. the edge opposite the folded edge is completely within the compartment and clearly distanced from the radially outer, open side of the compartment. In this position, the products are orientated laterally, i.e. in the direction of the rotation axis or in parallel to the compartment base respectively and subsequently clamped with a clamping arrangement directly or indirectly against the supporting surface.

Subsequently, the head-foot-trimming is carried out first, and then the front trimming. For the corresponding trimmings, a respective trimming arrangement is provided, which at least comprises a stationary counter blade as well as blades, which are arranged in the compartments and are moved along with these. The counter blade for the head-foot-trimming is arranged in the movement direction of the compartments prior to the counter blade for the front trimming.

The blades, moved together with the compartments for the head-foot-trimming, are arranged on axially open sides of the receiving compartments, the moved blade for the front trimming is arranged on the open side of the compartments parallel to the compartment base. The stationary counter blades are in suitable positions, in which they may interact with the moved blade in the manner of scissors. As the supporting components or components trimming the front edges need to be led past the counter blade for the head-foot-trimming, the product must be located at different depths in the compartment for the front trimming and the head-foot-trimming. In the known device the product must, thus, already be inserted deeply into the pocket during the reception, in order to be able to carry out the head-foot-trimming.

Prior to the head-foot-trimming the products are fixed in the compartment by the clamping arrangement. After the head-foot-trimming the clamping arrangement is released and the product is laterally gripped by a dislocating arrangement. The dislocating arrangement moves the product along a supporting surface out of the compartment into the position for the front trimming. The clamping arrangement is then activated again and the product is again clamped in the shifted position. After the front trimming, the clamping arrangement is again released and the product is moved through the dislocating arrangement as far out of the compartment as necessary so that it can be taken over by an onward conveyor.

In the known device the products are fed by a gripper conveyor and dropped into the compartments or inserted into them deeply, respectively. Hereby they glide along a supporting surface freely, until their folded edge is stopped at the support. During this process it may occur that the products and/or product parts are dislocated in relation to one another. For the lateral (axial) orientation of the products, before their being clamped, a relatively large distance or period respectively is provided, which corresponds to a movement of the compartments along a circular course over an angle region of e.g. 60°. All the same, it may occur that during the subsequent clamping by the clamping installation the products are not completely orientated, which may lead to impure trimmed edges.

Moreover, the product is only brought into position for the front trimming after the head-foot-trimming and in this position clamped on its front edge by the clamping arrangement. Particularly due to the change between the clamping by the clamping arrangement and by the dislocation installation an arching upwards of the intermediate product region not held by the dislocation installation may have occurred, such that the front edge is not fixed evenly but with folds or dislocations. This may also lead to trimmed edges with reduced edge quality.

An object of the invention is to prevent the disadvantages of the state of the art and to provide a device for trimming of folded printed products as well as a corresponding method, in which the position of the products for achieving an optimum quality trimming is easily controllable.

### BRIEF SUMMARY OF THE INVENTION

The device according to the invention includes, like the device described in connection with the state of the art, receiving compartments, which are formed by a supporting surface and are open in the periphery of the supporting surface on at least one, preferably three sides, such that moved along blades can be arranged here and may interact with stationary counter blades. The device further includes a support, which serves as rest or as a stop respectively for the folded edges of the products during or after insertion into the compartments respectively. The device also includes a trimming arrangement for the front trimming of the products and/or a trimming arrangement for the head-foot-trimming, which in each case includes moved along blades, arranged on the respective open sides as well as at least one stationary counter blade. As with the state, of the art a clamping and dislocating arrangement for clamping of the printed products and for dislocation along the supporting surface is provided. The clamping and dislocation arrangement advantageously acts on the lateral edges of the product.

According to the invention, the support is adjusted such that the products, when being taken over, are inserted into the compartments such that the front edge of the printed products opposite the folded edge is in the direct vicinity of the open side of the compartments after insertion into these. Unlike the prior art, the printed product is in particular inserted deeply into the compartment, but the front edge is at a smaller distance from the moved along blade for the front trimming. Advantageously, the front edge protrudes over these moved along blades or is gently moved into this position by being moved along the support. In this position the product, advantageously after alignment in lateral direction (i.e. running in parallel to the compartment base), is fixed by the clamping and dislocation arrangement on the lateral edges running in perpendicular to the folded edge. This happens before the first trimming is carried out. The lateral fixation is only released again, when the printed product is given over, wherein the product, if necessary, is brought, with the clamping and dislocation arrangement, into the effective position for trimming and for the giving over of the product.

The measures, in combination, have the following effect: The product is inserted less deeply into the compartments than according to the state of the art. Hereby, on the one hand, the distance over which the products fall freely is considerably reduced compared with the state of the art. Uncontrolled movements are thus prevented. Within the available time the products can thus be orientated with higher precision because the rough orientation is no longer necessary and can thus be omitted. Alternatively the length of the section of the course of movement, in which the orientation step takes place, may be reduced. Due to the fact that the lateral clamping is carried out directly after the orientation and is not released until the giving over, a formation of creases or a dislocation of the product parts is prevented by gripping and re-releasing. On the other hand the front trimming may be carried out directly after the orientation step without it being necessary for the product to be re-orientated inside the compartment. This results in an overall increased quality of the trimmed edge. For the head-foot-trimming the product generally needs to be drawn into the compartment, but this happens in an extremely controlled manner by means of the advantageously not released clamping on the lateral edges. Thus, even if a clamping device is used for fixing the front edge and is released after the frontal trimming, this has no influence on the quality of the trimmed edges.

Advantageously trimming arrangements are provided for the frontal trimming and the head-foot trimming, the stationary counter blades of which may possibly be switched away in the case that the corresponding trimming is not to be carried out. The stationary counter blades are advantageously arranged such that the front trimming is carried out first and then the head-foot-trimming.

For adaptation to different product formats the support is advantageously movable such that the product overhang beyond the blade for front trimming or the corresponding open side of the compartment, respectively, substantially always has the same width. The support is advantageously formed by one or several stationary elements, which are located in the region of the device, into which the products are inserted and subsequently orientated. Alternatively, the support may be implemented by means of a moved along and advantageously dislocateable compartment base.

The control arrangement for control of the clamping and dislocation arrangement may be designed in the form of a stationary control cam and interacting control elements.

The clamping and dislocation arrangement advantageously includes at least one clamping device with at least two clamping elements, which are able to take up a printed product between them and are movable in relation to one another from an open position and a clamping position by means of a controlling arrangement, e.g. in the form of a stationary control cam and co-operating control elements. In the simplest case, one of the clamping elements may be formed by the supporting surface of the compartment and the other one as a lever rotatable in relation to this surface. It is, however, preferred that the mutually co-operating clamping elements are independent of the supporting surface and, serving as dislocation installation, can be dislocated in relation to it to the compartment base or away from it respectively, in order to bring the product from the position for the front trimming into the position for the head-foot-trimming. The supporting surface may hereby serve as guidance for the corresponding clamping device.

Advantageously, a first clamping device for clamping the front edge as well as at least two further devices for clamping the lateral edges, running in perpendicular to it, are provided. The first clamping device e.g. acts together with the supporting surface, e.g. with a cross beam integrated in it or fastened to it. It must not, however, be moved along. The further clamping elements advantageously cooperate with counter elements movable in relation to the supporting area. The clamping devices for the front and lateral fixation are advantageously controllable independently from one another, such that the frontal clamping after carrying out of the front trimming may be released and the product may be brought into the position for the head-foot-trimming without it being necessary to release the lateral/side clamping.

### BRIEF DESCRIPTION OF THE DRAWINGS

Examples of the invention are shown in the drawings. In purely diagrammatic manner

FIG. 1 shows an overall view of the device according to the invention;

FIG. 2 shows a clamping and dislocation arrangement;

FIG. 3a and b show clamping and dislocation arrangements in a lateral view in closed, and respectively, open condition;

FIG. 4 shows a detailed view of the take-over region of the device in FIG. 1;

FIG. 5 shows a detailed view of the region of the device in FIG. 1, in which the front trimming is carried out;

FIG. 6 shows a detailed view of the region of the device in FIG. 1, in which the head-foot-trimming is carried out;

FIG. 7 shows a detailed view of the giving-over region of the device in FIG. 1.

### DETAILED DESCRIPTION OF THE INVENTION

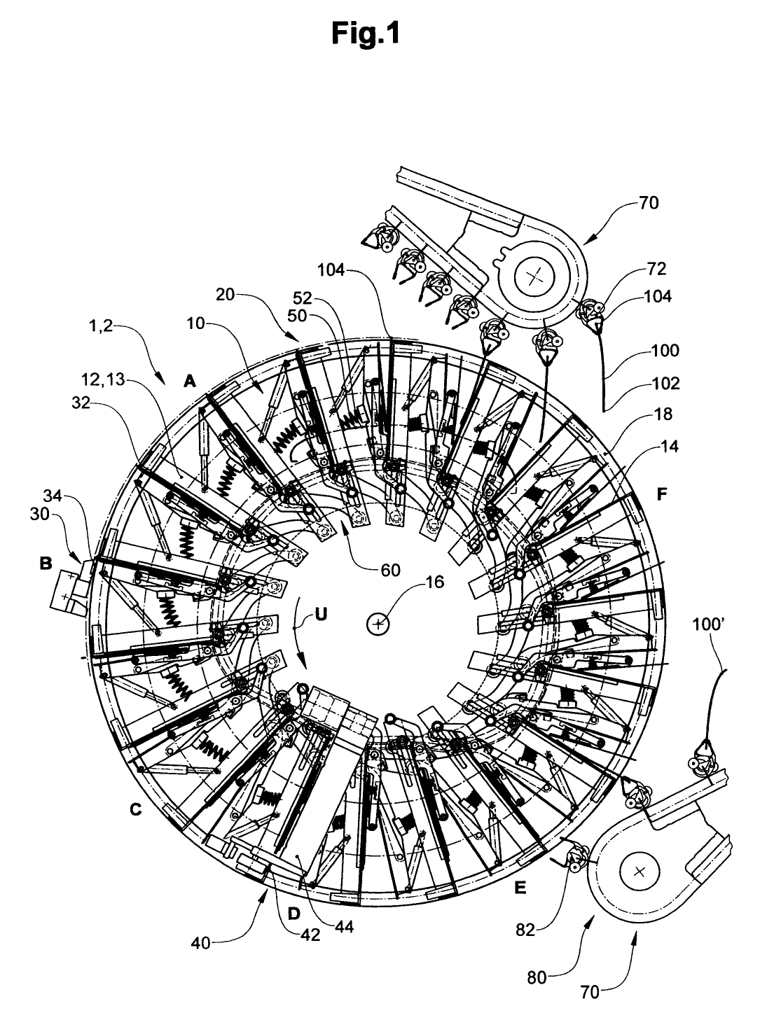

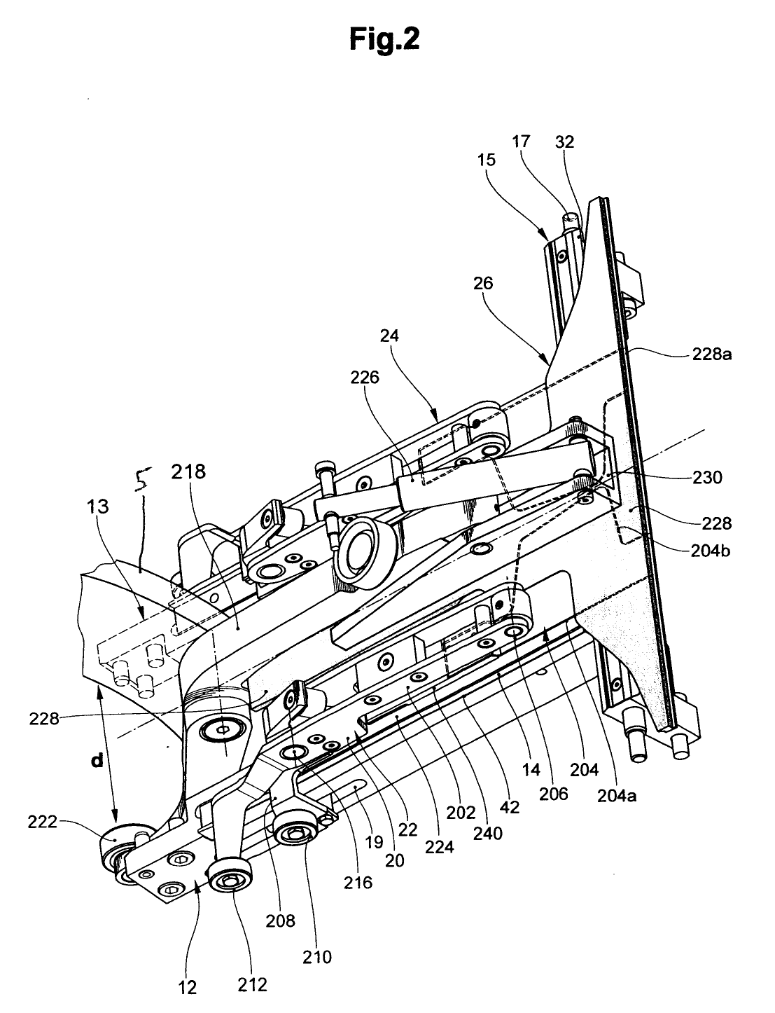

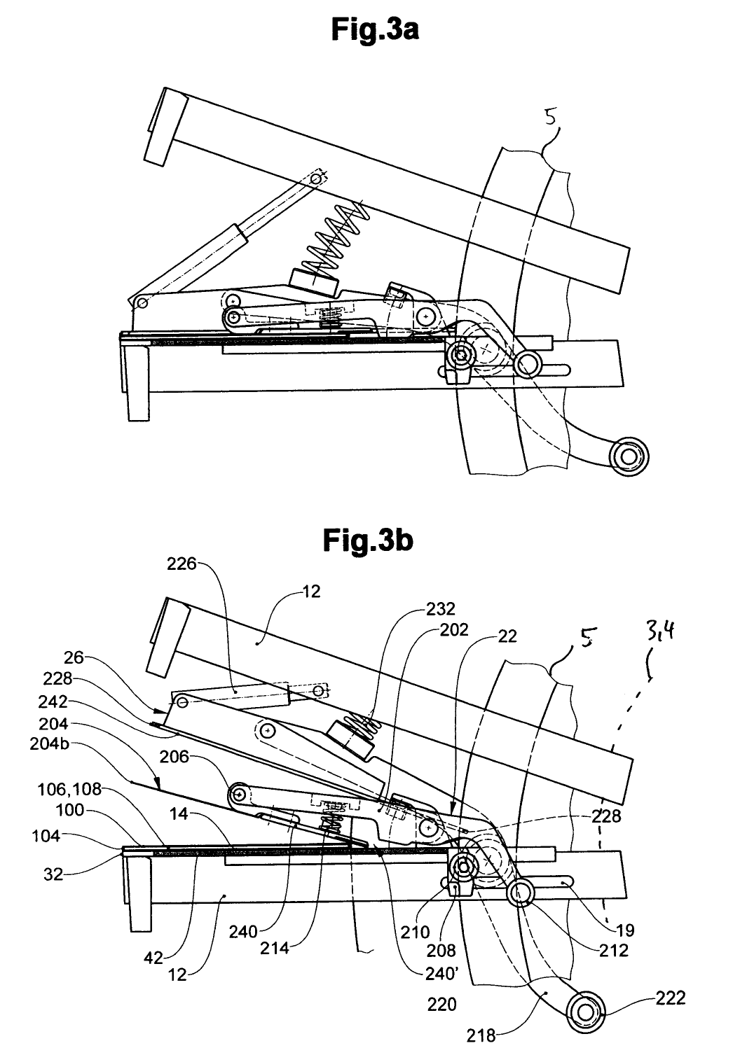

FIG. 1 shows the device according to the invention in a view from the side. The setup and functionality generally correspond to the device from publication EP-A 0753 386. Differences exist mainly in the succession of the trimming and in the design of the clamping and dislocation arrangement 20, which is illustrated in more detail in FIGS. 2, 3a and b. These differences are addressed in the following; in addition reference is made to EP-A 0753 386.

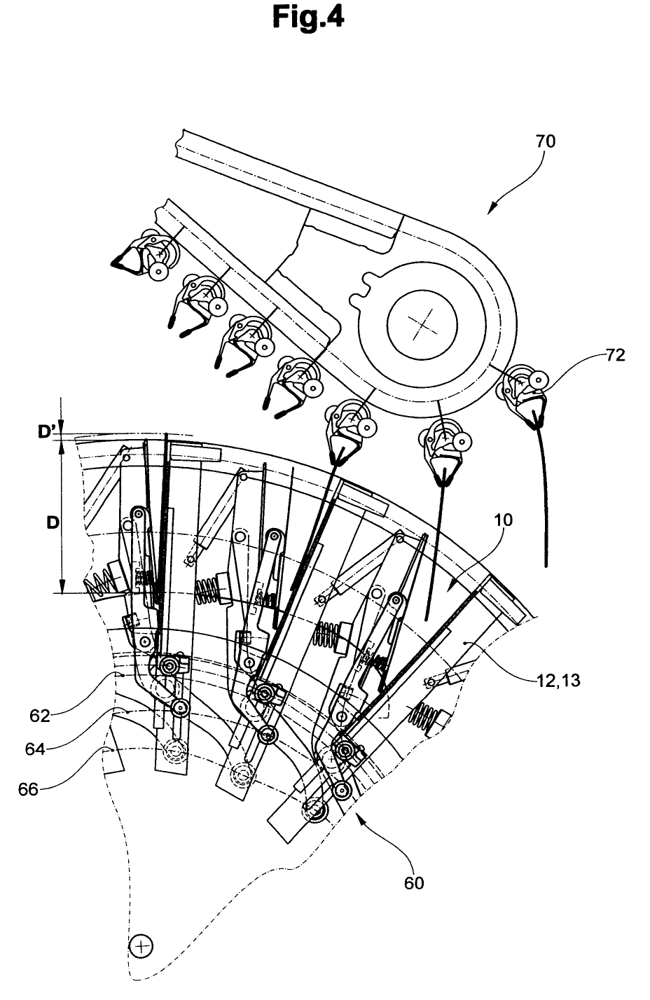

FIGS. 4-7 show details from the overall view and illustrate the individual method steps.

The device 1 comprises a processing drum 2 in a (not shown) frame, which drum is rotatable around its longitudinal axis 16. The processing drum 2 comprises a plurality of receiving compartments 10, which are orientated in a radial direction and are open on both faces of the processing drum 2. The compartments 10 are limited by supporting elements 12, 13, the top sides of which define a supporting surface 14 for the products 100. The compartments 10 are moved along a closed, here circular circuit U.

A traction conveyor 70 in the form of a gripper conveyor with a plurality of grippers 72 arranged above the device 1 serves for the insertion of printed products 100 with their folded edge 102 ahead into the compartments 10 from above. An onward conveyor 80 arranged laterally alongside the device 1 in the lower region, again in the form of a gripper conveyor with a plurality of grippers 82 serves for the take-over of the trimmed products 100 out of the compartments 10 and for their onward conveyance.

The compartments 10 contain in each case clamping and dislocation arrangements 20, with which the products 100 may be fixed in the compartments 10 and moved along the supporting area 14 substantially perpendicular to the rotation axis 16. The corresponding movements of the clamping and dislocation arrangement 20, are controlled with a control arrangement 60. The clamping and dislocation arrangement 20 is described with reference to FIGS. 2, 3a and b; the here stationary control cams 62, 64, 66 of the control arrangement 60 are easily identifiable in FIGS. 4-7.

A first trimming arrangement 30 serves for carrying the front trimming, i.e. for trimming of the edge 104 of the product 100 opposite the folded edge 102. Edge 104 will also be designated as front edge. A first trimming arrangement 30 comprises moved along knife elements 32 arranged in the compartments 10, orientated in parallel to the rotation axis 16 as well as a stationary counter blade 34. A second trimming arrangement 40 is for making the head-foot-trimming, i.e. for trimming of the lateral edges 106, 108 perpendicular to the folded edge 102. It comprises moved along blade elements 42, arranged in the compartments 10 which run perpendicular to the rotation axis 16 as well as a stationary blade arrangement with two counter blades 44.

In the upper region of the processing drum 2 a stationary support 50 is located, which defines the compartment base with its upper edge 52 and thus restricts the depth of insertion of the products 100 into the compartments 10. The folded edge 102 of the products 100 abuts against this support directly after the insertion.

In the following the clamping and dislocating arrangement is in detail described in reference to FIG. 2, FIGS. 3a+b.

The receiving compartments 10 are defined by several radially orientated longish support elements 12, 13, which are supported on two wheels 18. A first respective support element 12 and a second respective support element 13 define, with their surfaces orientated to compartment 10, a radially orientated support surface 14. The support elements 12, 13 are, on their ends facing rotation axis 16, fixed in the manner of spokes to a respective wheel 3, 4 (indicated diagrammatically in FIG. 3b). As described in EP-A 0 753 386, the distance d between the support elements 12, 13 or the wheels 3, 4 respectively can be adjusted in the direction of the longitudinal axis 16 in order to adapt to different product formats. On the radially outer end of the support elements 12, 13 and in parallel to the longitudinal axis 16, a cross beam 15 is located. The cross beam 15 has extensions 17 in the manner of pins with which it is fixed to a wheel 18 (FIG. 1) rotatable around axis 16. The support elements 12, 13 can, for format adaptation, be moved in the direction of the cross beam 15 in relation to it.

On the cross beam 15 the moved along blade elements 32 of the first blade arrangement are applied; the blades are directed outwards in a radial direction. The moved along blade elements 42 of the second trimming arrangement 40 are applied to edges located outwards in an axial direction of the support elements 12. Their blades face outwards in an axial direction. In the top view on the support area 14 the blades of the knife elements align with the respective edge of the support elements 12 or the cross beam 15 respectively or protrude over these.

A clamping and dislocating arrangement 20 is allocated to each compartment 10. This consists of two clamping devices 22, 24 for the lateral clamping and a clamping device 26 for the frontal clamping. The clamping devices 22, 24 for the lateral clamping are respectively identical in design; in the following one of the clamping devices is described.

The clamping device 22 for the lateral clamping in each case comprises a lever 202 with which in each case a pressing plate 204, consisting of a plane carrier element 240 and a thin plate 242 made of spring steel, is connected in a manner rotatable around an axis 206 parallel to rotation axis 16. A spring 214 presses the carrier element 240 in its radially inner region 240′ away from lever 202. This produces a pressing effect when the clamping device is closed, which first acts on the product regions located near the compartment base, i.e. from the folded edge 102 in the direction of the front edge 104, such that air possibly enclosed in the product is pressed out. The pressing plate 204 has an outer edge 204a parallel to the lateral edge of the supporting area 14 and expands in its radially outer end region 204b towards the inside of the supporting area 14. The clamping device 22 is operatively connected with a carriage 208, which is movable in a slot 19 of the supporting element 12 in radial direction.

The carriage 208 comprises a control element 210 in the form of a control roller. This acts together with a first stationary control cam 62, which is part of the control arrangement 60 for adjustment of the radial position.

The lever 202 is movable in relation to the support element 12 between an open position and a clamping position, in particular pivotable. For this purpose it is fixed to the carriage 208 to be pivotable around an axis 216. On its radially inner end it has a further control element 212, again in the form of a control roller. This element acts together with a second stationary control cam 64 (FIG. 4) for adjustment of the pivot position of the lever 202.

The clamping device 26 for the frontal clamping comprises a further lever 218 which is pivotable around a further axis 220 and is supported on a middle wheel disc 5 arranged between the two above mentioned wheels 3, 4 serving as support for the support elements 12, 13. The middle wheel disc 5 retains its position in a format adaptation, i.e. an axial change of distance of the outer wheels 3, 4 and is not adjusted. The clamping device 26 for the frontal clamping further comprises a pressing plate 228, which is T-shaped in the top view and which is pivotably connected via a longish coupling piece 230 to the further lever 218. The radially outer edge 228a of the pressing plate 228 runs in parallel to the rotation axis 16, to the blade for frontal trimming and in the present embodiment to the frontal edge of the product to be trimmed. The width of the frontal trimming at least corresponds to the maximal product width. In order for the frontal trimming pressing plate to be able to be moved past the counter blade for the lateral trimming the product in the present embodiment must be drawn back towards the compartment base.

The coupling piece 230 is on the one hand rotatably connected to the lever 218 and on the other hand, on its radially outer end via a telescopic rod 226, with the support element 12, 13 of an adjacent compartment 10 (FIG. 3a+b). Between the lever 218 and the adjacent compartment 10, a pressure spring 232 is arranged, which presses the lever 218 to the support surface 14. The pivot position of the further lever 218 may be adjusted against the spring effect with a third control cam 66 (FIG. 4), which acts together with a control element (control roller) arranged on the radially inner end of the further lever 218. In a closed condition of the lever 218 the frontal trimming pressing plate 228 presses the lateral trimming pressing plate 204 against the support elements 12, 13 or the cross beam 15, respectively.

In the region of the lateral edges of the support elements 12, there is preferably a counter clamping element 224, which acts together with the pressing plate 204 for lateral clamping, is coupled to the carriage 208 and is moved, when the carriage 208 is moved, in a radial direction. Its topside serves as part of the supporting surface 14.

The support 50 consists of one or more plane, stationary element, advantageously shaped like the segment of a circle, which extend on a plane perpendicular in relation to the rotation axis 16 and engage in-between the support elements 12, 13. They are advantageously movable for format adaptation. Their upper edge 52 is at a constant distance to the blades 32 or the distance decreases along the course of movement. In the latter case the product is at first arranged completely in the compartment and is raised again by the support 50 during the alignment into a position in which the frontal edge protrudes beyond the blade 32. This is a movement, which is preferably small compared to the movement necessary for the lateral trimming.

In the following, the functions of the clamping and movement arrangement 20 are described.

In open condition (FIG. 3b) the levers 202 of the lateral clamping devices 22, 24 as well as the lever 218 of the frontal clamping device 26 are in a position pivoted away from the support element 12, 13. In FIG. 3b, the pressing plates 204, 228 are aligned to each other in the view on the rotation axis. A printed product 100 can, thus, be introduced in-between the pressing plate 204 and the supporting area 14. By moving the lever 218 of the frontal clamping device 26 into a closed position (clamping position) the lever 202 of the lateral clamping organ 22, 24 is also brought into the clamping position. The product is pressed by the pressing plates 204, 228 on its lateral edges and on the front against the supporting surface 14, in particular against the counter clamping elements 224 (lateral edges) and the cross beam 15 (front edge). The outer edges of the pressing plates 204, 228 run in parallel and preferably as close as possible to the product edges to be trimmed. By means of the pivotability of the pressing plate 204 in relation to the lever 202 and the first spring 214, which presses the pressing plate 204 away from the lever 202 a good clamping acting homogeneously over a large area independently of the product thickness is produced and air is pressed out towards the front edge 104. Also, due to the pivotability of the front pressing plate 228 in relation to the lever 218 a good area clamping effect is achieved. A local moving of product parts and, thus, the formation of creases or dents on the clamped product is prevented.

Although the frontal clamping device 26 entrains the lateral clamping devices 22, 24 out of the open position into the closed position, the frontal clamping cannot be opened independent of the lateral clamping to bring the products 100 into the position for the lateral trimming after the frontal trimming, i.e. to move them towards rotation axis 16. By means of the spring 232 in-between the frontal clamping lever 218 and the adjacent support element 12, 13 differing product thicknesses may be compensated. In particular, it is prevented that too large forces act on the mechanical control cams and these components get jammed. The levers serve as rocker arms. The control cams need only bring about the counter force necessary for closing or opening respectively. The lateral clamping devices 22, 24 are supported, as mentioned above, on separate wheel discs and are controllable independently of one another, and are, however, moved together synchronically in parallel to the supporting surface 14 in operation. The frontal clamping organ 26 is supported independently on the middle wheel disc and is neither moved in a radial direction nor for format adaptation.

The function of the complete device 1 is described in reference to FIG. 1 and additionally FIG. 4 to 7.

As shown in FIG. 1 and FIG. 4, the products 100 are introduced in a taking over region with their folded edges 102 ahead by the grippers 72 of the feeder 70 into the compartments 10 and introduced in-between the support area 14 and the open clamping elements 22, 24, 26. In order to achieve an opening as large as possible the pressing plates 204, 218 are initially in a mutually aligned position (middle product 100 still held by the gripper 72 in FIG. 4). Subsequently the lateral clamping device 22, 24 and then the front clamping device 26 is approximated to the support area 14. Simultaneously the gripper 72 is opened and the product 100 is released.

In the taking over region, the stationary support 50 is located on the upper side 52 against which the folded edge 102 comes to lie. The support 50 is shaped and positioned such that its upper edge 52 has a predetermined distance D to the blades of the radially outer front trimming blade elements 32. This distance is adjusted such that it is smaller than the product length in an insertion direction (radial direction). Herewith, the inserted product 100 released by the gripper protrudes over the blade of blade 32 by predetermined value D′. Thus it is already in the position, in which the frontal trimming can be carried out.

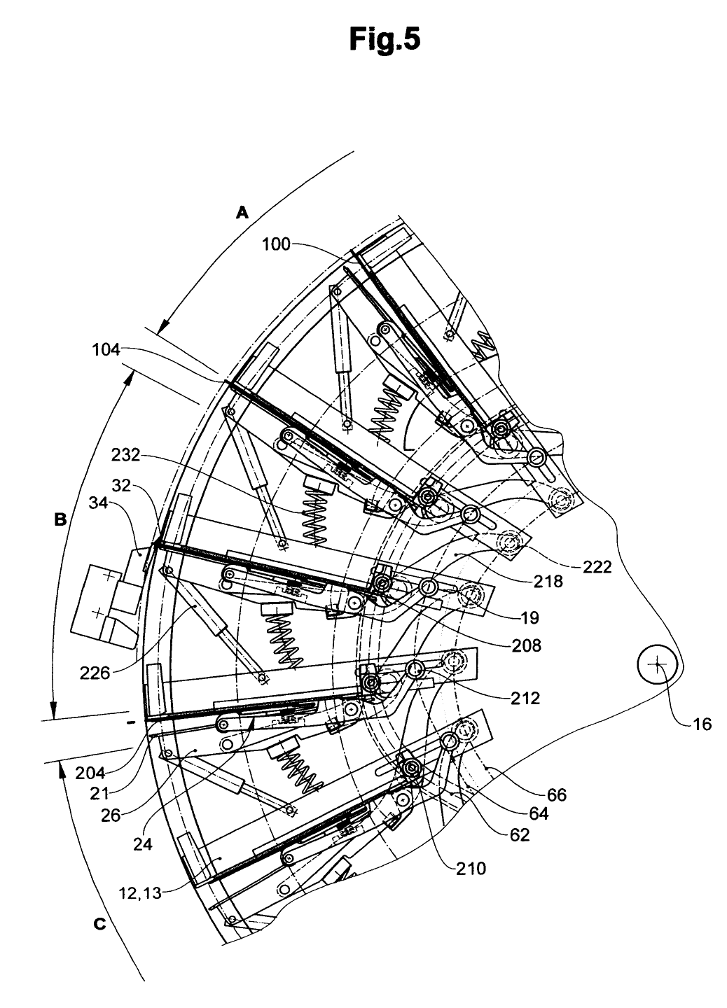

After insertion, the clamping organs 22, 24, 26 are approximated so far by corresponding shaping of the control cams 64, 66 responsible for the opening/closing that the product is positioned, seen in a circuit direction, largely in parallel to the support area 14, however, may be shifted in parallel to it. In the region A of the circuit, which extends over an angle region of ca. 60°, the product 100 is, by orientation elements not shown here, e.g. laterally arranged orientation tapes, orientated in the direction of the rotation axis 16. At the end of region A it is clamped by complete closing of the clamping devices 22, 24, 26 against the support area 14 or in the lateral region respectively against the movable counter clamping element 224 (FIG. 5 topmost and second to topmost compartment 10).

The region B follows, in which the stationary counter blade 34 is positioned and in which the frontal trimming is carried out. This region B extends over an angle region of ca. 30° (FIG. 5).

In the following region C, the frontal clamping device 26 is released and the product 100 is re-released at frontal edge 104 (lower compartment in FIG. 5). The carriage 208 is now, in closed condition of the clamping devices 22, 24 moved inward by a predetermined value (travel) b, which is not dependent on the product. The movement mechanism is, independently of the product format, always identically configured and travels by the same value b. The carriage 208 moves the lever 202 and the pressing plate 204 as well as the counter clamping element 224 inwards. The lateral clamping is hereby not released. The product 100, thus, remains well positioned over its whole area. The region extends over an angle region of approximately 50°.

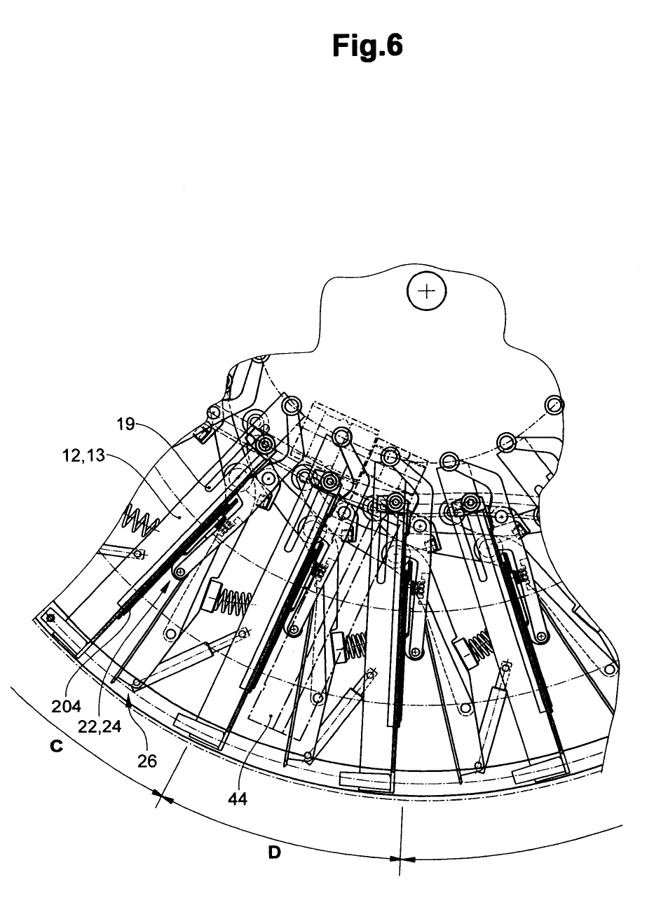

In the following region D (approx. 20°) the stationary counter blades 44 for the head-foot trimming are arranged such that the two lateral edges are trimmed simultaneously and in the same trimming direction (FIG. 6). For spatial reasons the radially outer ends of the counter blade 44 are inside the course of the moved blades 32 for the frontal trimming. Thus, it is necessary to move the products 100 inwards already before the head-foot-trimming (region C).

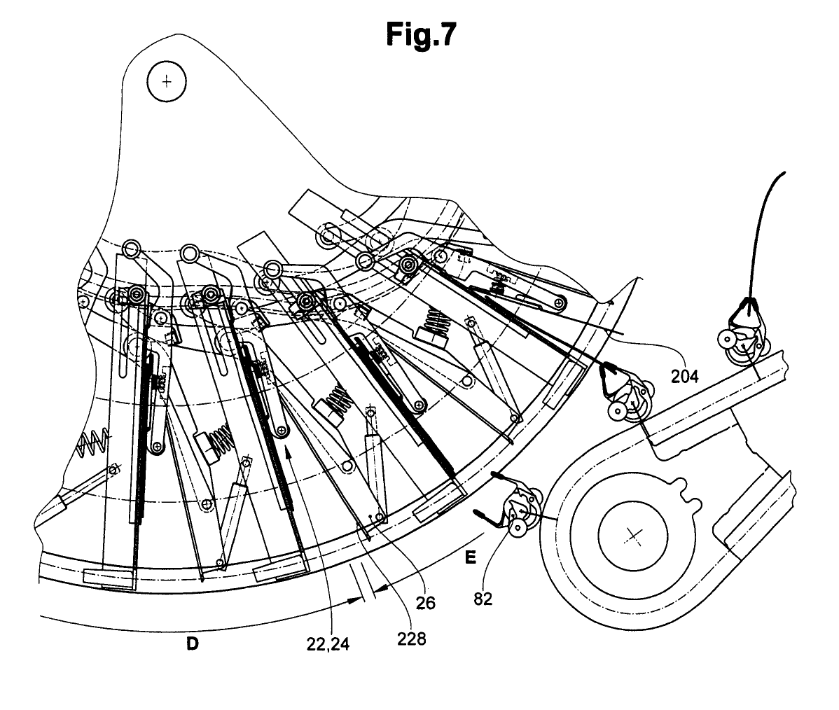

In subsequence to the head-foot-trimming the product with the clamping and moving arrangement 20 is moved outwards again into a position in which the frontal edge 104 protrudes beyond the frontal trimming blade 32, e.g. by 30 mm and can be gripped by the grippers (FIG. 7). The corresponding region E extends over an angle region of ca. 40°. At the end of the region E the clamping devices 22, 24 are opened for the lateral clamping, when the products 100 have already been gripped by the grippers 82. The transfer is, thus, carried out in a very controlled manner.

In the region F in-between conveying away and feeding the carriage 208, the clamping and moving arrangement 20 is moved inwards again fractionally, such that these may take their initial positions again in region A.

The invention has the advantage that it is not necessary to insert the product 100 completely into the compartments, when being given over by the feeder. Thus the product 100 is, directly after the giving over, in the right radial position for the frontal trimming, which is carried in direct subsequence to the orientation process. Thus, there is more time for orientation in Region A, such that it can be more precise. Furthermore, the product 100 is securely fixed after the orientation until it is given over to the onward conveyor 80 by the lateral clamping elements 22, 26 that may also be moved in a radial direction. The front edge 104 of the product 100 is preferably pressed against the support element 12 at first and then released after the frontal trimming has been carried out, in order for the product to be moved inwards. It is not necessary to clamp the product anew.

The device 1 shown in the figures merely shows a preferred embodiment of the invention. Within the concept of the invention further variants are possible: e.g. the product may be inserted into the compartments 10, not with its folded edge 102 first, but also in different manner. In this case the three edges of the product are trimmed, which are not the downstream edge. In case only a frontal or head-foot-trimming respectively is desired, the stationary blades 44 for the head-foot-trimming or the frontal trimming respectively can be brought into an inactive position. Besides, it is not compelling for the compartments to be implemented by means of a processing drum; they may also be formed by pockets, which are moved in succession along a closed circuit at fixed or variable distances. Instead of a stationary support, a support which is moved along, may be provided, e.g. an adjustable compartment base.

The frontal clamping by the frontal clamping device 26 is basically not compelling, but leads to an improved quality of trimmed edge. For frontal and lateral clamping the pressing plate 228 for frontal clamping must not necessarily overlap the pressing plates 204 for the lateral clamping; the pressing plates may be arranged side by side. An overlap, however, has advantages in the implementation of a pressing area, which lies in a common plane. Besides it is possible for the frontal clamping devices 26 to be movable together with the lateral clamping device 22, 24.

1. Device for trimming folded printed products, in particular newspapers, magazines and brochures, on at least one edge, comprising:
receiving compartments for the printed products to be trimmed comprising at least one supporting surface and a compartment base, wherein the compartments are driveable to circulate along a circuit in a circulation direction and are open at least on a first side opposite the compartment base;
a support, on which the printed product inserted into the receiving compartment comes to lie such that its folded edge is arranged in the region of the compartment base;
a first trimming arrangement comprising a plurality of blades moved along with the receiving compartments as well as at least one stationary counter blade;
a controllable clamping and moving arrangement associated with each receiving compartment for clamping of the printed products and for moving the printed products along the supporting area;
wherein
the support is designed such that an edge of the printed product opposite the folded edge is, after insertion into the compartment, in the direct vicinity of the first side of the compartment;
the clamping and moving arrangement is designed and controllable such that the printed products are fixed at least in the region of the lateral edges running perpendicularly to the folded edge before carrying out the trimming and are only released for transfer of the printed product.

2. Device according to claim 1, wherein the first trimming arrangement is adapted to carry out frontal trimmings, wherein the first trimming arrangement is moved along blades are arranged on the open first side of the compartments and wherein the support is designed such and the clamping and moving arrangement is designed and controlled such that the printed products, before being clamped by the clamping and moving arrangement protrude over the moved along blades of the first trimming arrangement.

3. Device according to claim 2, wherein the support is adjustable such that the distance between the support and the moved along blades of the first trimming arrangement is adaptable to the format of the printed products to be trimmed.

4. Device according to claim 1, wherein the compartments are open on the first side as well as on two second sides running perpendicularly thereto, and that at least one first trimming arrangement for carrying out frontal trimmings and a second trimming arrangement for carrying out head-foot-trimmings is provided, wherein the first and second trimming arrangements in each case comprise moved along blades on the open first and second sides of the compartments, respectively, and stationary counter blades, and whereby the stationary counter blades of the first trimming arrangement are arranged in a circulation direction ahead of the counter blade of the second trimming arrangement, such that the frontal trimming is carried out before the head-foot-trimming.

5. Device according claim 4, wherein the clamping and moving arrangement is designed and controlled such that the printed products are moved towards the compartment base in-between the frontal trimming and the head-foot-trimming.

6. Device according to claim 1, wherein the clamping and moving arrangement comprises at least one clamping device with at least two clamping elements, which are able to take a printed product between them and which are movable relative to one another between an open position and a clamping position.

7. Device according to claim 6, wherein the clamping and moving arrangement comprises at least three clamping devices for clamping the frontal edge opposite the folded edge, as well as the lateral edges, which run perpendicularly to the frontal edge, wherein the clamping device for the frontal edge is controllable and movable independently of the clamping devices for the lateral edges.

8. Device according to claim 7, wherein the axial distance of the clamping devices for clamping the lateral edges is adjustable for adaptation to different formats independently of the position of the clamping device for the front edge.

9. Device according to claim 1, wherein the receiving compartments are drivable around a common, preferably horizontal rotation axis, extend in a radial direction away from the rotation axis and are open on the radially outer first side as well as on both second sides running perpendicularly to the first side.

10. Method for trimming folded printed products, in particular newspapers, magazines and brochures, on at least one edge, comprising the steps of:
driving receiving compartments to circulate along a circuit, wherein the compartments comprise a supporting surface and a compartment base and wherein the compartments are open on at least one first side opposite the compartment base;
introducing the printed products into the compartments, such that they come to lie with their folded edge on a support in the region of the compartment base and such that the edge of the printed products opposite the folded edge is in the direct vicinity of the open first side after insertion into the compartments;
clamping the printed products with a clamping and moving arrangement, and thereby fixing the products in a region of their lateral edges extending perpendicularly to the folded edges before a trimming is carried out;
moving the printed products with the clamping and moving arrangement along the supporting surface;
trimming the printed products with at least a first trimming arrangement, which comprises a plurality of moved along blades as well as one respective stationary counter blade;
completely releasing the printed product only for the purpose of transferring it after completion of the trimming.

11. Method according to claim 10, wherein the first trimming arrangement is adapted for carrying out the frontal trimming, the method further comprising the step of trimming the printed products at least on their folded edge opposite the front edge and supporting them by the support, such that, before being clamped by the clamping and moving arrangement, they protrude over the moved along blades of the first trimming arrangement.

12. Method according to claim 10, further comprising the step of carrying out a frontal trimming by trimming the printed products on their front edge opposite the folded edge and then creating a head-foot-trimming by trimming the printed products on the lateral edges extending perpendicularly to the front edge.

13. Method according to claim 12, further comprising the step of clamping the printed products after insertion into the receiving compartments in the region of the frontal edges and on the lateral edges.

14. Method according to claim 13, further comprising the step of releasing the front edge after carrying out the frontal trimming, wherein the lateral edges are held in clamped condition.

15. Method according to claim 14, further comprising the step of moving the printed product towards the compartment base after release of the front edge without the two lateral edges being released and subsequently carrying out the head-foot-trimming.

16. Method according to claim 10, further comprising the step of moving the printed product away from the compartment base after carrying out the head-foot-trimming, such that it may be transferred to an onward conveying device.
